(19) United States
(12) Patent Application Publication
(10) Pub. No.: US 2007/0184239 A1
(43) Pub. Date: Aug. 9, 2007

(54) Yard waste storage and disposal system

(76) Inventor: John C. Mallory, Mt. Prospect, IL (US)

Correspondence Address: FACTOR & LAKE, LTD, 1327 W. WASHINGTON BLVD., SUITE 5G/H, CHICAGO, IL, 60607, US

(21) Appl. No.: 11/348,690

(22) Filed: Feb. 7, 2006

(51) Int. Cl. B32B 3/06

(52) U.S. Cl. 428/99

(57) ABSTRACT

A yard waste disposal storage and disposal system is disclosed that is suited for collection and biodegradable disposal of yard waste including leaves, sticks and other organic matter. According to one aspect of the invention, netting is attached to a web of biodegradable material and ties are provided for securing the netting and web about the yard waste.

### FIELD OF THE INVENTION

The present invention relates to a yard waste storage and disposal system that is suited for the collection and biodegradable disposal of yard waste including leaves, sticks, and other organic matter.

### RELATED APPLICATIONS

None.

### FEDERALLY SPONSORED RESEARCH OR DEVELOPMENT

None.

### BACKGROUND OF THE INVENTION

Yard waste such as leaves and small sticks are typically collected and disposed of in plastic or paper bags. In either case, the bags are relatively weak and can easily tear by the use of too much force to pack the bags, or because of sticks and the like protruding through the bags. Moreover, paper bags tear and fall apart easily when wet from rain or wet leaves. Additionally, plastic is not biodegradable, and plastic bags filled with yard waste thus cannot be disposed of as a whole as a biodegradable waste. Another problem with the use of bags is that they are awkward to hold open and fill.

The unique invention disclosed herein provides an alternative to the use of plastic or paper bags in the storage and disposal of yard waste.

### SUMMARY OF INVENTION

The present invention is directed to a yard waste storage and disposal system suited for collection and biodegradable disposal of yard waste including leaves, sticks, and other organic material. According to one aspect of the invention, netting is attached to a web of biodegradable material and ties are provided for securing the netting and the web about the yard waste.

In yet another embodiment, an apparatus is provided comprising a rectangular web of biodegradable material having a periphery and a planar inner surface with a length, a width, and a longitudinal center axis. Biodegradable netting is glued to the inner surface of the web. Further, ties extend from the netting and perpendicular to the periphery and the longitudinal center axis of the web.

In still another embodiment, an apparatus is provided comprising a rectangular web of biodegradable cellulous material having a periphery and a planar inner surface with a length, a width, and a longitudinal center axis. Biodegradable netting of jute twine, cord or rope is glued to the inner surface of the web. Also, ties are coupled to the netting and perpendicularly extend from the periphery and the longitudinal center axis of the web. Further, the web, in cooperation with the netting, at least partially contain the yard waste.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### DESCRIPTION OF THE DRAWINGS

The invention may be better understood with reference to the following drawings. The components in the drawings are not necessarily to scale, emphasis instead being placed upon illustrating the principles of the invention. In the drawings, like reference numerals designate corresponding parts throughout the several views.

FIG. 1 is plan view of an embodiment of a yard waste storage and disposal system in accordance with the present invention having a netting with a web of biodegradable material attached thereto;

FIG. 2 is a plan view of the netting of FIG. 1 with the web of biodegradable material detached therefrom;

FIG. 3 is a plan view of the web of biodegradable material of FIG. 1 with the netting detached therefrom; and,

FIG. 4 is a perspective view of the yard waste storage and disposal system of FIG. 1 secured about a bundle of yard waste.

### DESCRIPTION OF DETAILED EMBODIMENTS

The following descriptions of detailed embodiments are for exemplifying the principles and advantages of the inventions claimed herein. They are not to be taken in any way as limitations on the scope of the inventions.

In the FIGURES, the following reference numbers are used to depict corresponding elements wherein reference numbers having the same last two digits correspond to like elements:

Reference Number Element
10 yard waste storage and disposal system or apparatus
12 netting
14 web of biodegradable material
16 longitudinal lengths of jute twine, cord, rope or the like
18 lateral lengths of jute twine, cord, rope or the like
20 crease
22 grid pattern
24 intersections
26 ties
28 center axis
30 outer periphery
32 inner side of web
34 opposite or outer side of web
36 yard waste

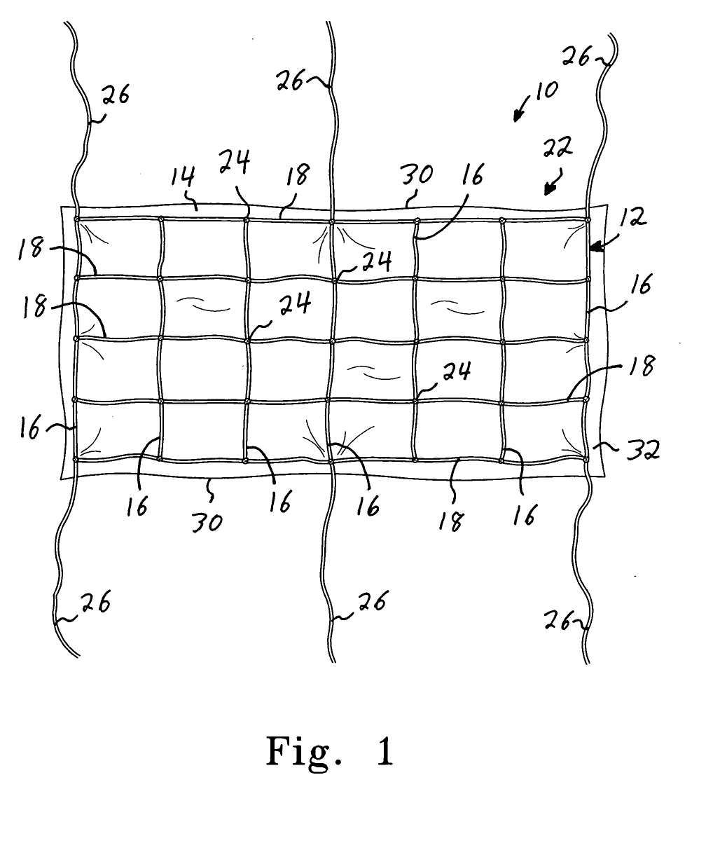

Turning to the FIGURES, and in particular to FIG. 1, a yard waste storage and disposal system or apparatus 10 in accordance with the present invention is depicted. In an embodiment, the apparatus 10 includes a netting 12 that is attached to a web 14 of biodegradable material.

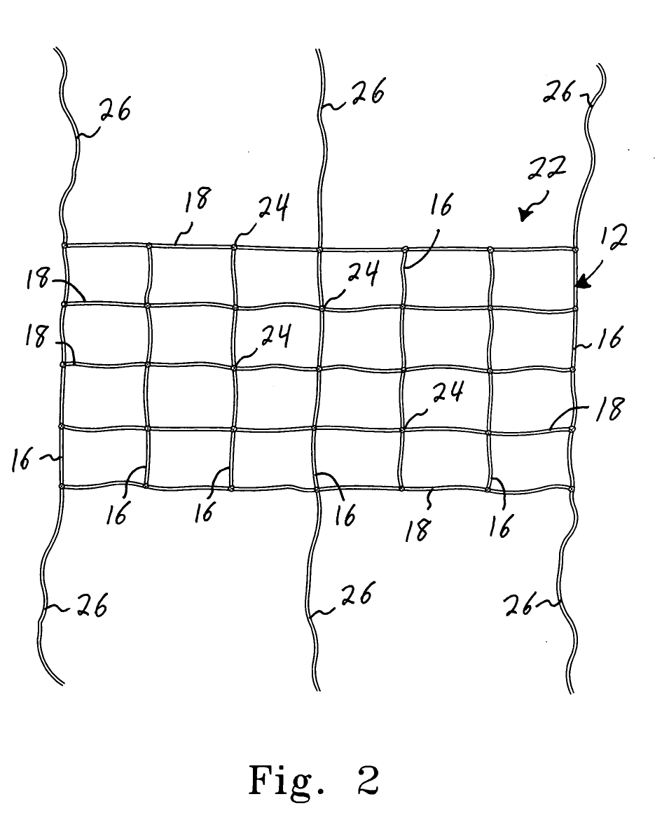

Turning to FIG. 2, the netting 12 includes a plurality of separate longitudinal lengths 16 and lateral lengths 18 of biodegradable jute twine, cord, rope or the like. The lengths 16 and 18 overlay each other to form generally a grid pattern 22. Accordingly, portions of the longitudinal lengths 16 and lateral lengths 18 intersect each other at regular intervals. At these intersections 24, the lengths 16 and 18 can be twisted, knotted, or woven together. Alternatively, the lengths 16 and 18 can merely overly each other or be attached together by conventional means such as, but not limited to, gluing together, tying together with another piece of jute twine, cord, rope or the like, or any other like means for attaching the lengths together.

In a preferred embodiment, but not necessarily, the lateral lengths 18 are spaced about four (4) inches apart. Further, the longitudinal lengths 16 are spaced about six (6) inches apart.

One or more of the longitudinal lengths 16 and/or lateral lengths 18 can freely extend from the netting grid pattern 22 to provide ties 26. Thus, the ties 26 can be coupled to the grid pattern 22. Preferably, however, the ties 26 are integral to the lengths 16 and/or 18.

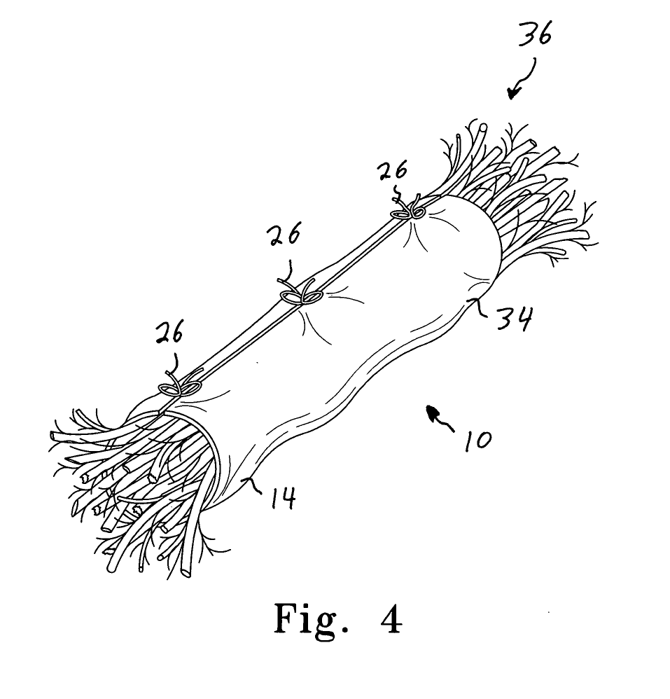

Accordingly, as shown in FIGS. 1, 2 and 4, but not necessarily, a portion of the longitudinal lengths 16 extending from the grid pattern 22 provide the ties 26. Moreover, the ties 26 can be equidistantly spaced apart from each other. In a preferred embodiment, but not necessarily, the ties can be twenty-four (24) inches in length.

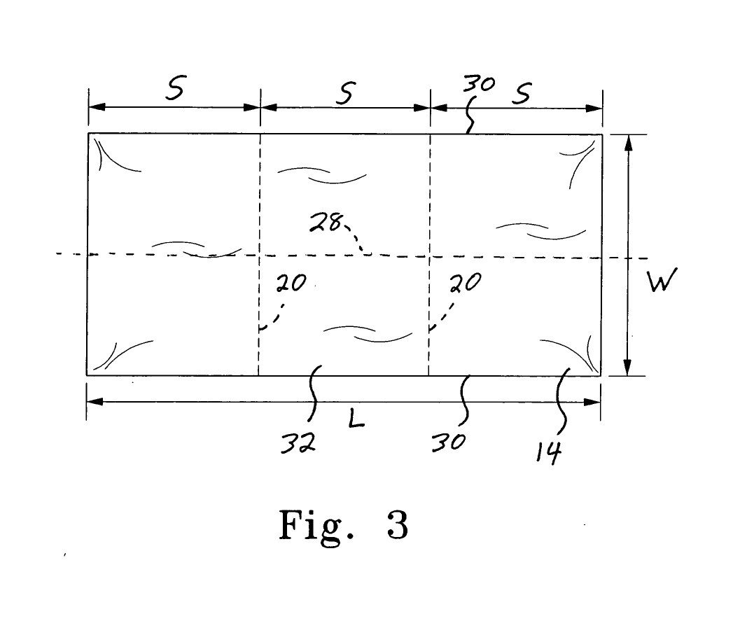

Turning to FIGS. 1 and 3, the web 14 is generally rectangular in plan view with a longitudinal center axis 28 and an outer periphery 30. Preferably, the web 14 is dimensioned to be larger in length and width than the grid pattern 22 of the netting 12 of FIGS. 1 and 2. Desirably, but not necessarily, the web 14 can consists of a continuous sheet of biodegradable compliant cellulous material such as a biodegradable paper or a paper-like material.

In an embodiment, but not necessarily, the web 14 has a length (L) of about thirty-six (36) inches and a width (W) of about sixteen (16) inches. Moreover, the web 14 can be longitudinally creased 20 at regular intervals to facilitate folding of the apparatus 10 before use, such as for shipping or storage. In an embodiment, but not necessarily, the creases 20 can having a spacing (S) of about twelve (12) inches apart.

As stated previously, the web 14 is preferably constructed of a biodegradable material. In an embodiment, but not necessarily, the web 14 is constructed of Kraft Paper from Smurfit-Stone Container Corporation, Chicago, Ill.

Turning back to FIG. 1, the grid 22 of the netting 12 is preferably attached to an inner side 32 of the web 14 by conventional means such as by gluing or the like. Accordingly, the ties 26 freely extend from the grid 22 and the web 14. In particular, the ties 26 extend from the outer periphery 30 of the web 14 and perpendicularly from the center axis 28.

In use, the apparatus 10 is laid flat upon the ground with side 32 facing up. Yard waste 34 is then placed on the apparatus. Next, the apparatus 10 is at least partially wrapped about the yard waste 34 such that it is at least partially contained. After that, the diametrically opposed ties 26 can be fastened or tied together. Then, the apparatus 10 containing the yard waste 34 can be disposed of in an environmentally friendly manner. Moreover, as indicated above, the apparatus 10 preferably complies with refuse pickup guidelines required by local municipalities.

It should be emphasized that the above-described embodiments of the present invention, particularly, any “preferred” embodiments, are possible examples of implementations merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention, and protected by the following claims.

What is claimed is:

1. An apparatus for storing yard waste, the apparatus comprising:
a rectangular web of biodegradable material having a planar inner surface with a length and a width; and,
a netting having a grid pattern with ties extending therefrom, the grid pattern having a length that is less than or equal to the length of the rectangular web and a width that is less than or equal to the width of the rectangular web, and the grid pattern attached to the planar inner surface of the rectangular web.

2. The apparatus of claim 1, the biodegradable material comprising a cellulous material.

3. The apparatus of claim 1, the biodegradable material comprising paper.

4. The apparatus of claim 1, the netting comprising a biodegradable material.

5. The apparatus of claim 4, the netting comprising jute twine.

6. The apparatus of claim 1, the grid pattern attached to the web by glue.

7. The apparatus of claim 1, the netting comprising jute twine, cord or rope.

8. The apparatus of claim 1, the grid pattern comprising at least two lengths of material attached together.

9. The apparatus of claim 1, the netting and web at least partially containing the yard waste.

10. An apparatus for storing yard waste, the apparatus comprising:
a rectangular web of biodegradable material having a periphery and a planar inner surface with a length, a width, and a longitudinal center axis;
a biodegradable netting glued to the inner surface of the web; and,
ties coupled to the netting and perpendicularly extending from the periphery and the longitudinal center axis of the web.

11. The apparatus of claim 10, the biodegradable material of the web comprising a cellulous material.

12. The apparatus of claim 10, the biodegradable material of the web comprising paper.

13. The apparatus of claim 10, the netting having a grid pattern.

14. The apparatus of claim 13, the grid pattern comprising at least two lengths of material attached together.

15. The apparatus of claim 10, the netting comprising jute twine, cord or rope

16. The apparatus of claim 10, the web and the netting at least partially containing the yard waste.

17. An apparatus for storing yard waste, the apparatus comprising:
a rectangular web of biodegradable cellulous material having a periphery and a planar inner surface with a length, a width, and a longitudinal center axis;
a biodegradable netting of jute twine, cord or rope glued to the inner surface of the web;
ties coupled to the netting an perpendicularly extending from the periphery and the longitudinal center axis of the web; and,
the web and the netting at least partially containing the yard waste.

18. The apparatus of claim 17, the biodegradable cellulous material of the web comprising paper.

19. The apparatus of claim 17, the netting having a grid pattern.

20. The apparatus of claim 19, the grid pattern comprising at least two lengths of material attached together.
